(19) United States
(12) Patent Application Publication
(10) Pub. No.: US 2006/0248391 A1
(43) Pub. Date: Nov. 2, 2006

(54) State machine-based command line debugger

(76) Inventors: Jeffrey Cannon Glover, Longmont, CO (US); Scott Sterling McDaniel, Villa Park, CA (US)

Correspondence Address: CHRISTIE, PARKER & HALE, LLP, PO BOX 7068, PASADENA, CA, 91109-7068, US

(21) Appl. No.: 11/205,852

(22) Filed: Aug. 16, 2005

Related U.S. Application Data
(60) Provisional application No. 60/677,000, filed on May 2, 2005.

(51) Int. Cl. G06F 11/00

(52) U.S. Cl. 714/30

(57) ABSTRACT

An apparatus for debugging an IC chip including an interface for converting serial off-chip data to parallel on-chip data and for converting parallel on-chip data to serial off-chip data and a state machine debugger coupled to the interface for receiving a command via the interface, executing the received command by accessing internal on-chip register or memory of the IC chip, and generating a response to the command for transmission over the interface.

### CROSS-REFERENCE TO RELATED APPLICATION

This Patent Application claims the benefit of the filing date of U.S. Provisional Patent Application Ser. No. 60/677,000, filed on May 2, 2005 and entitled “STATE MACHINE-BASED COMMAND LINE DEBUGGER,” the entire content of which is hereby expressly incorporated by reference.

### FIELD OF THE INVENTION

The present invention relates generally to electronic devices; and more particularly to a method and apparatus for debugging electronic devices.

### BACKGROUND OF THE INVENTION

Integrated Circuit (IC) devices typically include on-chip debugging circuitry that utilizes an on-chip processor for debugging of the IC. In general, on-chip debugging includes on-chip and off-chip hardware and software. The on-chip portion may be implemented in various ways. For example, a microcode based monitor or other hardware implemented resources may be introduced.

On-chip debugging also requires external hardware. For example, there must be a communications interface between the chip and the debugger host. A typical on-chip debugging environment includes an on-chip debugging host computer communicating with an on-chip debugging interface which may be a Joint Test Action Group (JTAG), Universal Asynchronous Receiver Transmitter (UART), or other similar interfaces.

In IC devices that include on-chip debugging capability, the host computer typically communicates with an on-chip processor. This on-chip debugging capability is possible when the chip has a processor and the processor is available for debugging purposes.

However, if a problem manifests itself in a mode where the on-chip processor is purposefully disabled (a power-down mode, for instance) then, the debugger functionality may not be available. Additionally, if the processor performs other tasks besides providing debug functionality concurrent with the debug functionality, using the command-line debugger may change the behavior of the device in such a way that it is difficult to diagnose a particular problem. Use of the on-chip debugger may also adversely impact the performance of system functions executing on the processor, if the processor is shared with debugger.

In a different case, if the on-chip processor is incorporated solely to provide debug functionality, the silicon area of the processor results in additional device cost.

Therefore, there is a need for an apparatus and method for debugging an IC that is not dependent on an on-chip processor.

### SUMMARY OF THE INVENTION

In one embodiment, the present invention is an apparatus for debugging an IC chip. The apparatus includes an interface for converting serial off-chip data to parallel on-chip data and for converting parallel on-chip data to serial off-chip data; and a state machine debugger coupled to the interface for receiving a command via the interface, executing the received command by accessing internal on-chip register or memory of the IC chip, and generating a response to the command for transmission over the interface.

In one embodiment, the IC includes an on-chip processor and the state machine debugger executes the received command independent of the on-chip processor.

In one embodiment, the present invention is a method for debugging an IC chip having an on-chip processor. The method includes receiving a debug command from a debugger host without utilizing the on-chip processor; changing a state of a state machine debugger to a new state responsive to the received debug command; and accessing an internal register or memory of the IC chip responsive to the new state without utilizing the on-chip processor.

In one embodiment, the present invention is an on-chip circuit for debugging an IC chip. The circuit includes a first interface for converting serial off-chip data to parallel on-chip data and for converting parallel on-chip data to serial off-chip data; a second interface for accessing internal registers or memory of the IC chip; a state machine debugger coupled to the first and second interfaces for receiving commands via the first interface and progressing through various states responsive to the received commands to generate via the second interface write or read cycles that target the internal registers or memory of the IC chip; and a register interface for configuring the first interface and the state machine debugger.

In one embodiment, the interface is a Universal Asynchronous Receiver Transmitter (UART) interface.

### BRIEF DESCRIPTION OF THE DRAWINGS

FIG. 1 is an exemplary block diagram of a system for debugging of an electronic device, according to one embodiment of the present invention;

FIG. 2 is an exemplary block diagram of a debug apparatus, according to one embodiment of the present invention;

FIG. 3 is an exemplary top-level state diagram of a debugger state machine, according to one embodiment of the present invention; and

FIG. 4 depicts an exemplary state transition sequence for a register read command, according to one embodiment of the present invention.

### DETAILED DESCRIPTION

In one embodiment, the present invention provides debug access to on-chip registers and memory through an external interface, for example, a serial port terminal. In this case, only two device pins are required, that is, serial receive data and serial transmit data. The debug access is available in the absence of a functioning on-chip processor, or on a device that does not include an on-chip processor. Further, the debugging capabilities are available on a device that includes an on-chip processor that is not functioning properly.

A user that desires to read or write on-chip registers or memory connects a device that includes the present invention to a personal computer (PC) or other computing devices running terminal emulation software. Once this is done and appropriate configuration options are set (i.e., baud rate, bits per byte, and parity), the user could execute commands to perform various debug operations, including, but not limited to, any of the following operations: register read, register write, register dump, memory read, memory write byte, memory write short, memory write long, and memory dump.

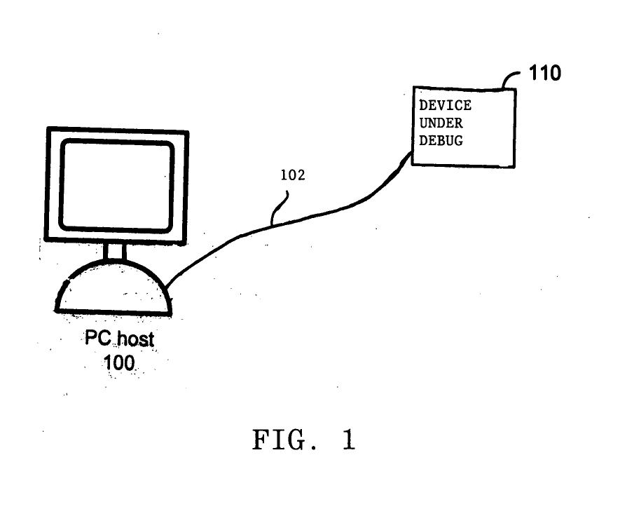

FIG. 1 is an exemplary block diagram of a system for debugging of an electronic device, such as an IC, according to an embodiment of the invention. A host computer 100 includes a communication interface for transmitting debugging commands to the device 110 (target device) and controlling the debugging of the target device 110. The target device 110 also includes a communication interface for receiving data from host 100. The communication interfaces may be a JTAG, UART, or other similar interfaces. The target device includes a state machine-based command line debugger, according to the present invention.

The silicon area consumed by the state machine-based debugger of the present invention is quite small, for example, approximately one-third the size of a small 8-bit CPU. Furthermore, the debugger can operate concurrently with on-chip firmware with insignificant system performance impact. The debugger can also operate in power-down modes as long as the internal register busses are active.

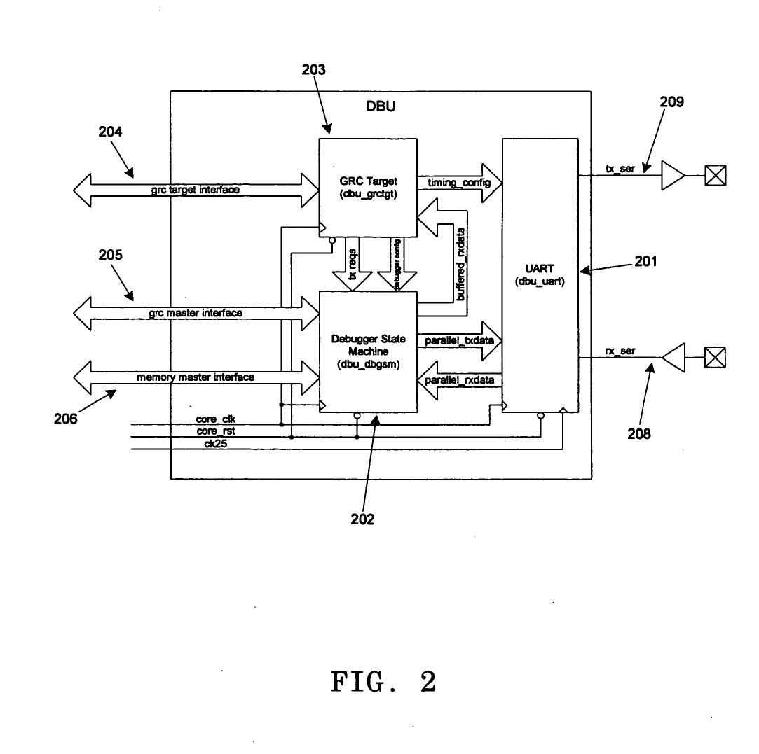

FIG. 2 is an exemplary block diagram of a Debug UART (DBU) 200, according to one embodiment of the present invention. The DBU 200 of the present invention performs general register controller (GRC) write and read cycles and memory write and read cycles from a remote terminal connected via a serial connection, such as a UART connection. The DBU supports these operations without substantial involvement of on-chip firmware or other external system busses that perform transactions as part of the normal functioning of a device. This way, debug cycles need not be inserted into the flow of transactions on whatever interconnect there is between the device under debug and the system in which the device is present. External system busses on a device that incorporates the DBU may include, but are not limited to PCI-E, PCI, PCI-X, ISA, VME, SATA, and the like.

A state-machine-based text debugger interprets and responds to commands from terminal software residing on a host computer. Additionally, the DBU allows a GRC master to send and receive individual bytes to/from the remote terminal via DBU's GRC target interface. A GRC master is a module that includes the ability to take control of the GRC bus. It can initiate register read or write cycles that are directed toward a GRC target. The DBU can be both a GRC master and a GRC target. It can initiate register read or write cycles via its master interface (205 in FIG. 2) and can respond to read or write cycles via its target interface (204 in FIG. 2).

As shown, the DBU 200 includes a UART block 201 for receiving and transmitting data. The UART receives parallel data from a debugger state machine 202 and serially transmits the received parallel data. Likewise, the UART receives serial data from a serial connection and communicates the data in parallel to the debugger state machine 202. The debugger state machine 202 communicates with a GRC target block 203 that includes a GRC target interface 204. There may be several GRC target blocks within the chip for accessing different registers/memory blocks of the chip.

In one embodiment, the UART block 201 supports 8-bit, No Parity, 1 stop bit (8/N/1) serial protocol. The UART provides a 16-bit programmable baud rate divider and a 16-bit programmable start bit sample time relative to the falling edge of the start bit. In this exemplary embodiment, the UART block includes the capability to flag bytes received with an incorrect value in the START or STOP bit with a receive error.

In one embodiment, the state machine debugger 202 supports 32-bit reads, writes, and dumps of register space, 32-bit reads and dumps of memory space, and 8-bit, 16-bit, or 32-bit writes to memory space. The state machine debugger is capable of accepting a Write Register command from the UART serial interface that allows writing of any single 32-bit aligned GRC addressor accepting a Read Register command that allows reading of any single 32-bit aligned GRC address, wherein a single 32-bit hexadecimal value is returned.

The state machine debugger is also capable of accepting a Dump Registers command that allows reading of data starting at a provided GRC address. If the provided address is 16-byte aligned, then each line of data returned to the terminal contains the starting address of the line, followed by four 32-bit words. If the provided address is 256-byte aligned, then sixteen lines are returned for each invocation.

Additionally, the state machine debugger is capable of supporting a Dump Registers Continuation feature whereby a register dump is resumed at the next 128-bit aligned address. This feature is invoked by sending only a carriage return at the command prompt following a register dump. If any other character is sent at this command prompt, the feature is disabled until the next dump registers command.

In one embodiment, the state machine debugger accepts a Memory Write Byte command that allows writing of any single byte in memory space, accepts a Memory Write Short command that allows writing 16-bit aligned 16-bit values in memory space, accepts a Memory Write Long command that allows writing 32-bit aligned 32-bit values in memory space, accepts a Memory Read command that allows reading of any 32-bit aligned 32-bit value in memory space, and accepts a Memory Dump command that allows dumping of 64 32-bit values from memory space. It is also capable of echoing all recognized characters sent by the terminal, with the exception of line feeds.

The GRC target (dbu_grctgt) 203 allows for transmission and reception of single characters, configuration, and status readback. It connects to the GRC target interface 204 to communicate with other GRC target block in the chip. It responds to and completes GRC write and read requests that are received on the target interface. Furthermore, it provides configuration values to the other two blocks in DBU. Status can be read from a register within dbu_grctgt. The block provides the means for a GRC master to transmit serial characters. This is accomplished by writing a register within dbu_grctgt. A GRC master can also receive serial characters via the GRC target interface, by reading a register in dbu_grctgt.

In one embodiment, the GRC target 203 presents two 16-bit output busses that connect to dbu_uart for the purpose of configuring UART timing. The first value, first_bit_sample_offset[15:0] specifies the number of a clock (e.g., ck25 in FIG. 2) cycles that pass from the falling edge of the START bit to the time when the START bit is sampled. The second value, bit_interval[15:0], specifies the number of ck25 cycles that pass between the sampling of one bit to the sampling of the next bit for receive, and the duration of each bit for transmit. See the description below of dbu_uart for more information about the effect of these values on UART behavior.

Use of the first_bit_sample_offset and bit_interval count settings for sampling the UART data allows operation of the UART at standard speeds such as 9600, 19200, and the like, without the requirement for an exact multiple of those clock rates. Traditional UART devices require a clock source that is 8× or 16× the buad rate for proper operation. The UART portion of the present invention is capable of working with any reasonably fast (25 Mhz or higher) clock rates. The divisor values can be adjusted to minimize input sampling and output frequency errors in the UART signals.

In one embodiment, the GRC target 203 contains two registers and one configuration bit to allow direct configuration of UART timing by a GRC master. There is one register to configure first_bit_sample_offset[15:0] and another to configure bit_interval[15:0]. These registers are in the upper 16 and lower 16 bits, respectively, of one GRC 32-bit aligned address. The mode bit, called timing_override, is at a different GRC address from the two timing registers. The timing_override bit defaults to a state of zero out of reset, which disables the override, thereby allowing the default UART timing of 19200 baud with a 25 Megahertz clock.

In one embodiment, a programmable bit (e.g., debug_sm_en) enables or disables the debug state machine. The state of this bit is presented to dbu_dbgsm. This bit defaults out of reset to a value of one, which enables the debug state machine. See the description of dbu_dbgsm below for more information about the effect of this configuration bit.

In one embodiment, a programmable bit (e.g., crlf_en) enables the transmission of a carriage return preceding each line_feed sent by the debug state machine. The state of this bit is presented to dbu_dbgsm. This bit defaults out of reset to a value of one, which enables the transmission of carriage return before each line feed. See the description of dbu_dbgsm for more information about the effect of this configuration bit.

In one embodiment, a register (e.g., tx_data) allows for direct transmission of bytes via the serial interface. The act of writing this register causes the written data to be presented to dbu_dbgsm, along with assertion of a transmit data request to dbu_dbgsm. When dbu_dbgsm accepts the data, it asserts a transmit data acknowledge to dbu_grctgt. The state of the transmit data request is observable via the status register, so a GRC master can know whether data transmission is pending. If a GRC master writes the tx_data register when the request is already asserted, dbu_grctgt does not acknowledge the GRC write request until dbu_dbgsm acknowledges the earlier request, thereby freeing up the tx_data register inside of dbu_grctgt.

In one embodiment, dbu_uart accepts (and acknowledges) a byte to be transmitted at the same time that it is driving the start bit onto the wire. Therefore, this register is immediately available for another byte of data while the first byte is being shifted out. This gives a GRC master a little more than one full byte time (10 bit times) to provide the next byte to be transmitted.

In one embodiment, a register (e.g., rx_data) allows for direct reading of bytes that arrive from the serial interface. Whenever a character is received, the character is visible in this register. The bottom eight bits of the register reflect the data; the ninth bit contains the value of the receive error signal from the UART that goes along with the received byte. The ninth bit is not persistent from byte to byte, if one byte is in error and the following byte is not, it is set for the first byte and clear for the second regardless of whether the byte was read from the register.

In one embodiment, a status bit (e.g., rx_data_valid) is set whenever a character is received into the rx_data register. The act of reading the rx_data register clears the rx_data_valid bit. Also, a bit (e.g., rx_error) is set whenever the UART delivers receive data with an error. This bit remains set until it is written with a value of one, at which point it clears and remains so until another erroneous byte is received.

In one embodiment, a bit (e.g., rx_overflow) is set whenever the UART delivers receive data and rx_data_valid is already set. This bit remains set until it is written with a value of one, at which point it clears and remains so until another receive overflow occurs.

In one embodiment, dbu_dbgsm provides a byte to dbu_grctgt once the entire byte has been received. The byte remains available until another complete byte is received, which means that a GRC master has 10 bit times to read the rx_data register before an overflow condition occurs.

The debugger state machine 202 implements a command line debugger in hardware. In one embodiment, it accepts and generates 8-bit ASCII characters from and to dbu_uart to provide a command-line debugger interface with eight commands: write register, read register, and dump registers, write byte to memory, write short to memory, write long to memory, read memory, and dump memory. The debugger state machine generates GRC and MA master transactions on its GRC and MA master interfaces to write and read data as required to complete the aforementioned register and memory commands. The debugger state machine also allows for the insertion of characters into the transmit stream when they are provided by dbu_grctgt.

A GRC Master Interface 205 is capable of generating GRC master transactions conforming to a GRC master interface protocol. The interface is used to access on-chip registers. Optionally, a second interface, MA Master Interface 206, is capable of providing MA master transactions for on-chip memory access.

Although some embodiments of the present invention are described with respect to a GRC master, a GRC master interface and a GRC target interface, those skilled in the art would understand that the present invention is not limited to a GRC. Rather, the debugger is capable of interfacing with any master device and any target device. That is, the debugger of the present invention is capable of accessing registers and/or memory of other target devices via the (grc) target interface.

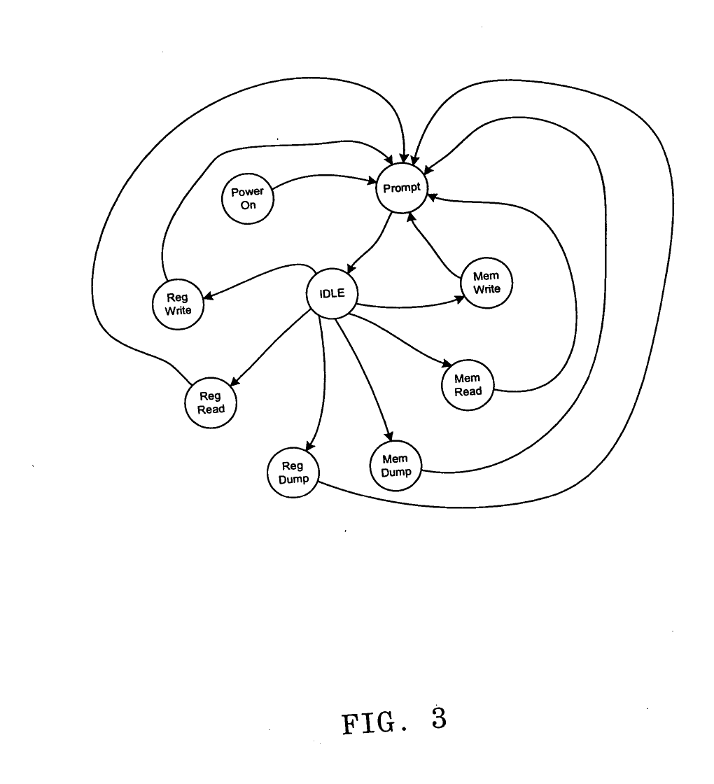

In one embodiment, the debugger includes a user interface (UI) that may be enabled or disabled, based on input from the debug_sm_en bit described above in the dbu_grctgt block. FIG. 3 is an exemplary top-level state diagram of a debugger state machine, according to one embodiment of the present invention. If debug_sm_en is set, which is the default value out of reset, then the debugger state machine is active. If the debugger state machine is disabled, then it ignores all received data from the UART and transmits only data that is supplied by dbu_grctgt. When core_rst_b is released, the debugger state machine immediately transmits the prompt character sequence which is an optional carriage return (if crlf_en is asserted), a line feed, and a ‘>’. At this point, the debugger enters a state where it awaits a command. The state machine remains in this state indefinitely until the first character of a command is given.

In one embodiment, eight commands are formatted as follows:

| | |
|---|---|
| w<addr> <data><CR> | (write register) |
| r<addr><CR> | (read register) |
| d<addr><CR> | (dump registers) |
| ml<addr> <long_data><CR> | (memory write long) |
| ms<addr> <short_data><CR> | (memory write short) |
| mb<addr> <byte_data><CR> | (memory write byte) |
| mr<addr><CR> | (memory read) |
| md<addr><CR> | (memory dump) |

In one embodiment, the debugger tolerates either upper-case or lower-case characters for both commands and arguments. The debugger tolerates a line feed at any time, and ignores it. It is neither processed by the state machine nor echoed. If the UART delivers a received character to the debugger with the error bit set, then the character is treated as unexpected and any partially composed command is aborted.

In one embodiment, if any character other than w, r, d, m, or carriage return is typed at the prompt, then the character is treated as unexpected and the command aborted. The debugger expects the first character of the address immediately following the command character(s), without a separating space. For the write register, write memory long, write memory short, and write memory byte commands, the debugger terminates the address argument when it receives the space that separates the address argument from the data argument. For all other arguments, the debugger terminates the argument when it receives a carriage return.

In one embodiment, both the address and data arguments represent 32-bit values, with the exception of the ms and mb commands, in which case data arguments are 16-bit and 8-bit, respectively. The debugger tolerates the case where fewer than eight/four/two hexadecimal digits are entered for an argument. If fewer than eight/four/two digits are provided, then the debugger assumes that the most significant un-entered digits have a value of zero. However, the debugger expects that at least one hexadecimal digit be provided for each argument. If an attempt is made to terminate an argument where no hexadecimal digits have been received, then the debugger interprets the terminating character as unexpected and aborts the command.

In one embodiment, if an argument already contains eight/four/two hexadecimal digits where the most significant digit is non-zero and an additional digit is received, then the additional digit is treated as an unexpected character and the command is aborted. On the other hand, if an argument already contains eight/four/two or more hexadecimal digits where the digit in bit positions [31:28]/[15:12]/[7:4] is equal to zero, then additional digits are tolerated without aborting the command. This behavior is specified to allow detection of more than eight/four/two hexadecimal digits without a digit counter.

In one embodiment, all address arguments are interpreted as byte addresses. The bottom two bits are ignored for all commands that read or write 32-bit data; the bottom bit is ignored for the memory write short (ms) command; none of the bits are ignored for the memory write byte (mb) command.

In one embodiment, all expected characters that are received by the debugger are echoed, with the exception of carriage returns and line feeds. Unexpected characters are not echoed, but result in an aborted command (see below.)

In one embodiment, if a command is aborted as the result of an unexpected character, the unexpected character is not echoed. However, a bell character (CTRL-G) is transmitted, followed by a carriage return (if crlf_en is set), a line feed, a ‘?’ character, and a prompt sequence. Typically, aborted commands never result in GRC or MA master cycles. Typically, aborted commands always result in the clearing of the “register dump active” and “memory dump active” flags.

In one embodiment, commands that are properly formed and terminated with a carriage return result in execution of the given command. Execution typically involves GRC master or MA master read or write cycles.

For example, in the case of a register write command, the “register dump active” and “memory dump active” flags are cleared. The GRC master interface presents the address and data on the GRC master bus along with a write request. When the request is acknowledged by the GRC block, dbu_dbgsm displays a new prompt sequence and is ready to accept the next command.

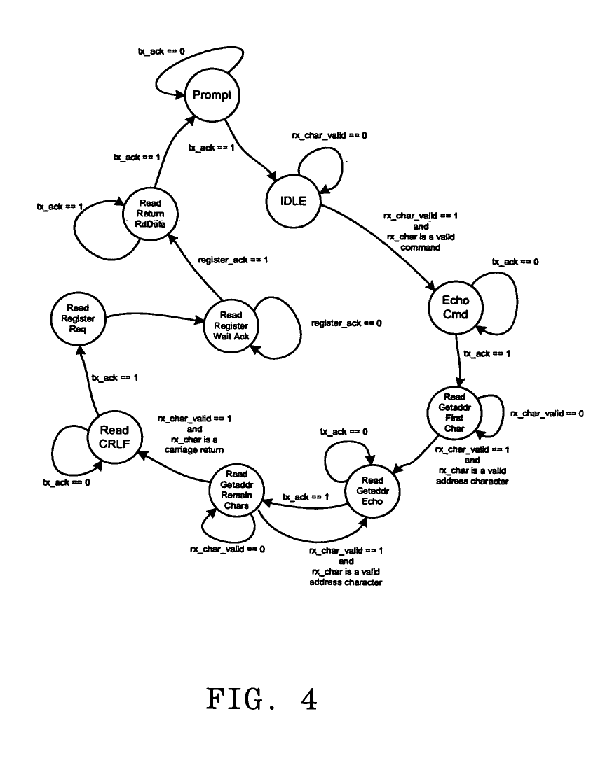

FIG. 4 depicts an exemplary state transition sequence for a register read command. The debug state machine would normally be in the “IDLE” state when it is waiting for a command. If the user types a command character (e.g., r, w, d, or m), then the state machine transitions to the “Echo Cmd” state. In this example, assume that the user typed an “r”, to initiate a register read.

While in the “Echo Cmd” state, a request to transmit the command character is asserted to the UART. Once the UART accepts the character by asserting its transmit acknowledge, the state machine transitions to the “Read Getaddr First Char” state where it waits for the user to type the first character of the address to be read.

Once a character is typed, the state machine transitions to the “Read Getaddr Echo” state where a request is once again asserted to the UART. Once the UART acknowledges the character, the state machine transitions to the “Read Getaddr Remain Chars” state.

For each address character that is typed, the state machine transitions to the “Read Getaddr Echo” state, then back to the “Read Getaddr Remain Chars” state. Finally, when a carriage return is received, the state machine transitions to the “Read CRLF” state where the state machine asserts its request to transmit a carriage return/line feed sequence. Once the UART acknowledges the carriage return and line feed, the state machine transitions to the “Read Register Req” state.

In the “Read Register Req” state, a register read request is presented on the GRC master interface (FIG. 2, 206). The state machine immediately transitions to the “Read Register Wait Ack” state.

In the “Read Register Wait Ack” state, the state machine waits for a GRC acknowledge. When it sees an acknowledge, it transitions to the “Read Return RdData” state. In this state, a request is sent to the UART to transmit the 32-bits (eight characters) of read data. When the UART has acknowledged all of the data, the state machine transitions to the prompt state.

In the prompt state, a request is sent to the UART to transmit a carriage return, a line feed, and a“>” character. Once the UART acknowledges these three requests, the state machine returns to the IDLE state.

In the case of a register dump command, in one embodiment, dbu_dbgsm executes the following steps:
Transmit an optional carriage return and line feed.
Clear the bottom two bits of the supplied address. This becomes the “current” address.
Set the “register dump active” flag. Clear the “memory dump active” flag.
Transmit the current address as hexadecimal digits.
Transmit a ‘:’ character.
Transmit a whitespace character.
Perform a GRC Master cycle for the current address. Capture returned data.
Transmit the returned data as hexadecimal digits.
Increment the current address by 4.
If the current address bits [7:2] are equal to zero, transmit a prompt sequence. The operation is now complete. Do nothing further.
If the current address bits [3:2] are equal to zero, then transmit an optional carriage return followed by a line feed and go to step 3.
Go to step 6.
If a carriage return is received on a blank line and the register dump active flag is set, then perform a register dump at the current address leftover from the previous dump registers operation. This behavior continues until a command other than dump register is given, or until a command is aborted.

In one embodiment, memory write long, write short, and write byte commands are similar to the register write command except that MA master cycles are generated, rather than GRC master cycles. The memory read command is similar to the register read command except that MA master cycles are generated rather than GRC master cycles. The memory dump command is similar to the register dump command except that MA master cycles are generated rather than GRC master cycles. Also, this command clears the “register dump active” flag and sets the “memory dump active” flag.

The GRC target 203 provides the aforementioned debug_sm_en bit. When this bit is set, debugger operation is as described above. When it is clear, the command line debugger is disabled. It does not transmit a prompt and it does not respond to commands typed by the user. The debugger state machine 202 provides to GRC target 203 a bus that holds the most recently received character and error flag status from dbu_uart 201, regardless of whether or not debug_sm_en bit is set.

In one embodiment, the debugger state machine 202 accepts and transmits, via dbu_uart, bytes that are presented for transmission by dbu_grctgt. This function is available even if the debug_sm_en bit is clear. If debug_sm_en is set, bytes provided by dbu_grctgt are transmitted immediately, with higher priority for transmission than bytes provided by the debugger itself.

In one embodiment, the debugger state machine presents 8-bit data to be transmitted to dbu_uart 201, along with a transmit request. The transmit data and the request remains stable until dbu_uart acknowledges the request, at which point the next byte of data may be presented on the bus. Dbu_uart 201 presents 8-bit data along with an error flag to dbu_dbgsm, along with a data valid strobe.

Dbu_dbgsm captures the data on the cycle where the strobe is asserted.

For example,

>w80035bf0 cabba6e5
(This is a register write command to address 0x80035bf0 with
data 0xcabba6e5)
>r80035bf0
cabba6e5
(This is a register read command to address 0x80035bf0. Data
of 0xcabba6e5 is returned, as it was just written in the
previous command.)
>d80035b00
80035b00: 00000000 00004000 00000000 00000000
80035b10: 00000000 000000ff 00000000 00000000
.
.
.
80035bf0: cabba6e5 13579bdf 00000000 c000c035
(This is a register dump command starting at address
0x80035b00. 16 rows of four 32-bit values are returned.)
>
80035c00: 12345678 23478573 42197421 12824184
.
.
.
80035cf0: 32593259 abc23932 235197ae 12492900
(In this case, a carriage return was entered by the user on a
blank line immediately following a register dump command. This
keystroke invoked the register dump continuation feature, where
16 more lines of data are returned starting at the address
immediately following the previous register dump.)
>wb000 10
(This is a register write command, where less than 32 bits of
address and data were provided. The remaining un-entered bits
are assumed to have a value of zero.)
>r0000b000
00000010
(Another register read where all 32-bits of the address were
supplied (four trailing zeros were not necessary). The user
could have type “rb000” to get the same result.)
>r000000000b000
00000010
(Shows that any number of trailing zeros are tolerated.)
>d80035cec
80035cec: 71492421
80035cf0: cabba6e5 13579bdf 00000000 c000c035
(This shows what happens when the user starts a register dump
at a non 256-byte aligned address. Specifically, the first
line of the dump has only one 32-bit data word, rather than the
usual four. Also, only two lines are returned, rather than
16.)
>
80035d00: 12345678 23478573 42197421 12824184
.
.
.
80035df0: 32593259 abc23932 235197ae 12492900
(The register dump is invoked again)
>j
?
(An invalid command (there is no “j” command). A “?” character
is echoed in this case.)
>mw4000 1234
(A 32-bit memory write to address 0x4000 with data of 0x1234.
The data is extended to 0x00001234 to make 32 bits.)
>mr4000
00001234
(A memory read at address 0x4000)
>md4000
00004000* 00001234 00013412 49148211 12421414
00004010* 14812728 4728abe9 01400140 13290000
.
.
.
000040f0* 12491891 a142bc19 abce812f edbca912
(A memory dump at address 0x4000. Output is similar to the
register dump command, with the exception that each address is
followed by “*” rather than “:”)

In one embodiment, the UART (dbu_uart) 201 supports transmitting and receiving 8-bit serial data. The data is framed with one logic-0 start bit and one logic-1 stop bit, for a total of ten bits per character transmitted or received. Dbu_uart 201 supports flexible timing programmability via the 16-bit first_bit_sample_offset and bit_interval inputs. In one embodiment, the UART performs rudimentary integrity checking on received data, by verifying the framing bits of each received symbol. Symbols that are received with framing errors are marked as such when data is passed to dbu_dbgsm.

Note that all signals that interface with debugsm are synchronous to a clock (e.g., core_clk in FIG. 2), while the serial transmit and receive data is generated and sampled on different clock (e.g., ck25 in FIG. 2). This makes the uart baud rate settings independent of core_clk frequency.

In its idle state, dbu_uart drives its tx_serial output 209 to a logic “1”. When dbu_dbgsm presents a byte of data to be transmitted, along with a transmit request, dbu_uart accepts the byte by asserting tx_ack. Dbu_uart drives the start bit (logic-0) on tx_serial for bit_interval[15:0] clock cycles. It then drives data bit 0 (the least significant bit of data on the parallel input from dbu_dbgsm) on tx_serial for bit_interval[15:0]. This is repeated for data bits 1 through 7, in that order. Finally, dbu_uart drives the stop bit (logic-1) on tx_serial for bit_interval[15:0] clocks. Once bit_interval[15:0] clocks have passed, dbu_uart may drive the start bit for the next byte of data, if dbu_dbgsm's request is asserted. If dbu_dbgsm's request is not asserted, then dbu_uart continues to drive logic 1.

Dbu_uart's serial receive input 208 is typically not synchronous to ck25, so it is first synchronized to ck25 with a two-flip-flop synchronizer. Both flip-flops in this synchronizer are set when core_rst_b is asserted; i.e., their outputs are always at logic one when core_rst_b is released. The serial receive logic within dbu_uart samples the output of the synchronizer, looking for a falling edge. When one is found, the error flag is cleared. Simultaneously, a timer is started to wait first_bit_sample_offset[15:0] clocks before sampling for the start bit. Dbu_uart should find a value of logic “0” when it samples the start bit. If it does not, then dbu_uart sets the error flag for this byte, but continues receiving the remainder of the byte.

Once the start bit has been sampled, dbu_uart waits until bit_interval[15:0] clock cycles have passed, at which point it samples data bit 0 (the least significant bit of the 8-bit parallel word to be formed.). The timer is re-armed, and dbu_uart waits an additional bit_interval[15:0] clock cycles before sampling data bit 1. This is repeated until all eight data bits have been sampled.

Following the sampling of the last data bit (bit 7), the timer once again is re-armed. When bit_interval[15:0] clock cycles have passed, the stop bit is sampled. Dbu_uart should see a value of logic-1 for the stop bit. If it does not, dbu_uart sets the error flag for the byte. Once the stop bit has been sample, the 8-bit data and the error flag is presented to dbu_dbgsm, along with a data valid strobe. This strobe is asserted regardless of whether there was an error on the start and/or stop bits. Once the data valid strobe has been asserted, then the receive logic returns to idle and wait for another falling edge on its input.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. An apparatus for debugging an Integrated Circuit (IC) chip comprising:
an interface for converting serial off-chip data to parallel on-chip data and for converting parallel on-chip data to serial off-chip data; and
a state machine debugger coupled to the interface for receiving a command via the interface, executing the received command by accessing internal on-chip register or memory of the IC chip, and generating a response to the command for transmission over the interface.

2. The apparatus of claim 1, wherein the IC includes an on-chip processor and the state machine debugger executes the received command independent of the on-chip processor.

3. The apparatus of claim 1, wherein the interface is an Universal Asynchronous Receiver Transmitter (UART) interface.

4. The apparatus of claim 1, wherein the UART) interface includes first counter for determining a position to sample a first bit in a character of the data and a second counter for determining a position to sample subsequent bits in the character.

5. The apparatus of claim 1, wherein the received command is one or more of the group consisting of a register read command, a register write command, a register dump command, a memory read command, a memory write command, and a memory dump command.

6. The apparatus of claim 1, wherein the interface includes internal registers for configuring the interface.

7. The apparatus of claim 6, wherein the registers of the interface are accessible by the state machine debugger.

8. The apparatus of claim 1, further comprising a master device interface for initiating register read and write operations on a plurality of target devices.

9. A method for debugging an Integrated Circuit (IC) chip having an on-chip processor, the method comprising:
receiving a debug command from a debugger host without utilizing the on-chip processor;
changing a state of a state machine debugger to a new state responsive to the received debug command; and
accessing an internal register or memory of the IC chip responsive to the new state without utilizing the on-chip processor.

10. The method of claim 9, further comprising configuring the state machine debugger for a particular bit rate operation.

11. The method of claim 9, wherein the debug command is received via an Universal Asynchronous Receiver Transmitter (UART) interface.

12. The method of claim 9, wherein the received command is one or more of the group consisting of a register read command, a register write command, and a register dump command.

13. The method of claim 9, wherein the received command is one or more of the group consisting of a memory read command, a memory write command, and a memory dump command.

14. The method of claim 9, further comprising powering down the on-chip processor before receiving the debug command and accessing the internal register or memory of the IC chip.

15. An on-chip circuit for debugging an Integrated Circuit (IC) chip comprising:
a first interface for converting serial off-chip data to parallel on-chip data and for converting parallel on-chip data to serial off-chip data;
a second interface for access internal registers or memory of the IC chip;
a state machine debugger coupled to the first and second interfaces for receiving commands via the first interface and progressing through various states responsive to the received commands to generate via the second interface write or read cycles that target the internal registers or memory of the IC chip; and
a register interface for configuring the first interface and the state machine debugger.

16. The circuit of claim 15, wherein the first interface is an Universal Asynchronous Receiver Transmitter (UART) interface.

17. The apparatus of claim 15, wherein the received command is one or more of the group consisting of a register read command, a register write command, and a register dump command.

18. The circuit of claim 15, wherein the received command is one or more of the group consisting of a memory read command, a memory write command, and a memory dump command.

19. The circuit of claim 15, further comprising means for powering down the on-chip processor before receiving the debug command and accessing the internal register or memory of the IC chip.

20. The circuit of claim 19, wherein the register interface is accessible by the state machine debugger in response to a received configuration command.
